(19) United States
(12) Patent Application Publication
(10) Pub. No.: US 2026/0111388 A1
(43) Pub. Date: Apr. 23, 2026

(54) METHOD AND SYSTEM FOR FACILITATING CHIPLET COMMUNICATION

(71) Applicant: Marvell Asia Pte Ltd, Singapore (SG)

(72) Inventors: Shruti Sinha, Pune (IN); Akhilesh Rathi, Pune (IN)

(21) Appl. No.: 19/361,605

(22) Filed: Oct. 17, 2025

(30) Foreign Application Priority Data
Oct. 18, 2024 (IN) 202441079142

(51) Int. Cl. G06F 13/42

(52) U.S. Cl. CPC G06F 13/4282; G06F 2213/0012

(57) ABSTRACT

Methods for chiplet communication and accompanying chiplets, integrated circuits, design structures are disclosed herein. According to an embodiment, a method of chiplet communication includes receiving, at a chiplet, a command via a serial peripheral communication interface. The method further includes parsing, by the chiplet in an uninitialized state, the command into a packet associated with an operation performable by the chiplet and performing, by the chiplet in the uninitialized state, the operation based on the command parsed. Chiplets and chiplet communication as described may be useful for configuring or initializing out of reset chiplets using a secondary or peripheral serial interface, for example, for extra short range link bring-up or peripheral component interface express initialization.

### RELATED APPLICATION

This application claims priority under 35 U.S.C. § 119 or 365 to India, Application No. 202441079142, filed Oct. 18, 2024. The entire teachings of the above application are incorporated herein by reference.

### BACKGROUND

Chiplets are small, modular silicon dies that may be combined to form a larger system. Unlike conventional monolithic die architectures, chip designs utilizing chiplet architectures may integrate a number of smaller, individual chiplets. Chiplets may further be integrated heterogeneously, wherein a given chiplet may be optimized for a dedicated function of the system, e.g., general-purpose processing, memory access, input/output operations, and other functions. Such architectures may provide a number of advantages, including, but not limited to, scalability, cost efficiency, optimized performance of a given task performed by a dedicated chiplet, or higher yield rates with regards to defects in silicon dies.

### SUMMARY

Chip designs utilizing heterogenous architectures may include at least a host chiplet with an onboard processing unit and one or more target chiplets without onboard processors. In such multi-die designs, initialization of high-speed interconnects between individual chiplets may be critical for effective functioning of the chip. Furthermore, because the target chiplets may not have an onboard processor, instructions for programming registers on the target chiplet, e.g., the registers for the high-speed interconnects, may need to be transmitted from the host chiplet and executed using hardware logic controls.

Methods and systems for chiplet communication disclosed herein may be useful for programming and initializing chiplets. As non-limiting examples, the methods of chiplet communication described herein may be useful for initializing high-speed interconnects between chiplets during chiplet bring-up and configuration, for querying a status of the chiplet, or for asserting a reset of the chiplet. The methods and systems for chiplet communication may continue to be used following configuration or bring-up of the chiplets.

An example embodiment is directed toward a method of chiplet communication, for example, communicating with a target chiplet in an uninitialized state. The method includes receiving a command, at a chiplet, via a serial peripheral communication interface and parsing, by the chiplet in an uninitialized state, the command transmitted into a packet associated with an operation performable by the chiplet. The method further includes performing, by the chiplet in the uninitialized state, the operation based on the command parsed.

The operation performed may include resetting the chiplet, transmitting a status of the chiplet, writing a value to a register at a given address, or transmitting a value from the register at the given address. Writing the value to the register at a given address may initialize at least a portion of the chiplet. Initializing at least a portion of the chiplet may include establishing a physical link layer configured to communicatively couple the chiplet to a host chiplet.

The method may further include parsing, by the chiplet in an initialized state, a subsequent command into a subsequent packet associated with a subsequent operation performable by the chiplet and performing, by the chiplet in the initialized state, the subsequent operation based on the subsequent command parsed.

Performing the operation may include identifying a start field of the packet, checking a register address corresponding to a register address field of the packet, the register field associated with the operation, and identifying a command field of the packet.

Another example embodiment is directed toward a chiplet. The chiplet includes a communication module configured to couple communicatively to a host chiplet via a serial peripheral communication interface. The communication module is further configured to, the chiplet being in an uninitialized state, convert signals received through the serial peripheral communication interface into a command. The chiplet further includes hardware logic communicatively coupled to the communication module. The hardware logic is configured to, the chiplet being in the uninitialized state, execute the command.

The communication module may include a protocol layer, the protocol layer configured to parse the command into a packet associated with an operation performable by the hardware logic. The hardware logic executing the command may include performing the operation. The operation performed may include resetting the chiplet, transmitting a status of the chiplet to the host chiplet, writing a value to a register at a given address, or transmitting the value from the register at the given address to the host chiplet. The packet may include at least a start field, a register address field, a command field, and an end field.

The serial peripheral communication interface may include an inter-integrated circuit (I2C) communication interface. The serial peripheral communication interface may also include other interfaces, for example, serial peripheral interface (SPI) or improved inter-integrated circuit (I3C).

The hardware logic may include a finite state machine. The finite state machine may include logic for processing the command parsed.

The chiplet may further include a physical layer. The hardware logic may be configured to initialize at least a portion of the physical layer by executing the command.

The hardware logic may further be configured to, the chiplet being in an initialized state, execute a subsequent command. The chiplet may be configured to continue receiving commands via the serial peripheral communication interface after initialization of the chiplet and to execute the commands.

Another example embodiment is directed toward an integrated circuit. The integrated circuit includes a host chiplet and at least one target chiplet. A chiplet of the at least one target chiplet includes a communication module communicatively coupled to the host chiplet via a serial peripheral communication interface. The communication module is configured to, the chiplet being in an uninitialized state, convert signals received through the serial peripheral communication interface into a command. The chiplet further includes hardware logic communicatively coupled to the communication module and configured to, the chiplet being in the uninitialized state, execute the command.

Another example embodiment is directed toward a target chiplet. The target chiplet includes means for receiving a command via a serial peripheral communication interface and means for parsing the command received into a packet associated with an operation performable by the chiplet in an uninitialized state. The target chiplet further includes means for performing the operation based on the command parsed.

A further example embodiment is directed toward a hardware description language (HDL) design structure encoded on a machine-readable data storage medium. The HDL design structure includes elements that when processed in a computer-aided design system generates a machine-executable representation of an initialization block of a chiplet. The HDL design structure includes a communication block configured to couple communicatively to a host chiplet via a serial peripheral communication interface. The communication module is further configured to, the chiplet being in an uninitialized state, convert signals received through the serial peripheral communication interface into a command. The HDL design structure further includes hardware logic communicatively coupled to the communication block. The hardware logic is configured to, the chiplet being in the uninitialized state, execute the command.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 illustrates schematically an example embodiment of an integrated circuit including a host chiplet and at least one target chiplet.

FIG. 2 schematically illustrates an example embodiment of a chiplet configured to implement a C2C communication protocol.

FIG. 3 illustrates schematically an example embodiment of a C2C module of a target chiplet.

FIG. 4 illustrates schematically a block diagram of a C2C communication module, according to an example embodiment.

FIG. 5 illustrates schematically states of a state machine that may be used for chiplet communication, according to an example embodiment.

FIG. 6A illustrates a template for a packet transmitted from a host chiplet to a target chiplet using C2C communication, according to an example embodiment.

FIG. 6B illustrates an example packet that may be transmitted from a host chiplet to a target chiplet following the template of FIG. 6A.

FIG. 7 illustrates an example embodiment of a method for configuring a target chiplet in a system with heterogenous chiplet architecture.

FIGS. 8A and 8B illustrate example workflows performed by a host chiplet for read and write transactions, respectively for registers of a target chiplet, according to an example embodiment.

### DETAILED DESCRIPTION

A description of example embodiments follows.

Chiplets are small, modular semiconductor dies that may be designed to operate in conjunction with other chiplets to form a more complex system. Chiplet architectures may offer advantages over conventional monolithic chip designs. For example, chips composed of multiple chiplets, which may include multiple heterogenous chiplets, may be more cost effective to manufacture, improve manufacturing yield, and include individual chiplets optimized for specific tasks or operations.

For integrated circuits (ICs) or systems on a chip (SoCs) incorporating chiplets, interfacing and communication between chiplets may be an important factor in determining performance of a chip or system. Example interfaces or interconnects that may be useful for optimal inter-chiplet communication may include universal chiplet interconnect express (UCIe), an open industry standard interconnect for on-package connectivity between chiplets that offers high bandwidth, low latency, and power efficient communication. A physical layer (PHY) of communication interfaces like UCIe may include, for example, extra short reach (XSR) or ultra short reach (USR) links that may communicatively couple a given chiplet to another given chiplet. Additional methods for ensuring efficient chiplet-to-chiplet communication may include 2.5 dimensional (2.5D) or 3 dimensional (3D) geometries, wherein parallel interconnects or interposers may be applied to stack chiplets, which may reduce data and clock signal travel distances between chiplets.

However, initialization and bring-up of chiplets, which may include programming of registers for communication links and interfaces described hereinabove, may be necessary for chiplets in an out-of-reset state. In some embodiments of heterogenous chiplet architectures, at least a portion of the chiplets may not include a processor and may therefore have no software support for performing initialization when out of reset.

For example, some embodiments of heterogenous chiplet architectures may include a host chiplet, which includes a processor, and one or more target chiplet, which may not include a processor. The host chiplet may perform key functions of discovery, initialization, and bring-up of the system for operation, including for the target chiplets. Furthermore, the initialization may include configuring of communication interconnects between the host chiplet and the target chiplet. Methods for initializing a system from the host chiplet may be advantageous if they do not require software intervention and if they are simple to implement, scalable to support multiple target chiplets, and/or efficient in power consumption.

Methods for chiplet communication and accompanying chiplets, integrated circuits, and hardware designs are described herein. The chiplet communication may be useful for at least one of chiplet bring-up, e.g., initialization of chiplets from an out-of-reset state, querying a status of a chiplet, or resetting a chiplet. The chiplet communication may further be used in an initialized chiplet or after initialization of chiplets, e.g., for querying the status of the chiplet or resetting the chiplet.

The method may include a protocol designed over a serial peripheral communication interface/protocol, for example, inter-integrated circuit (I2C), serial peripheral interface (SPI), improved inter-integrated circuit (I3C), or other communication interfaces. As described herein, an embodiment for chiplet communication utilizing I2C may be referenced as chiplet I2C (C2C) or peripheral I2C (P2C). Additionally, as disclosed herein, I2C may be referenced as an example or a preferred embodiment. However, it should be understood by one of ordinary skill in the art that other communication interfaces or protocols may be used.

The C2C/P2C protocol may define a set of commands for performing one or more of resetting a target chiplet, reading important bring-up status of target chiplets, or initializing chiplet interconnects (e.g., XSR). A host chiplet having a single I2C master may be capable of initializing chiplet interconnects on multiple target chiplets using the C2C protocol. Restated, C2C may utilize I2C as a transport medium and may define specific commands with unique command codes for initial configuration of the chiplets.

According to some example embodiments, a C2C/P2C block may be useful for one or more of the following features or functional capabilities: providing an indirect address register (IAR) for register transactions for an access bridge between a baseband physical layer (BPHY) and a compute input/output bus (IOB) (e.g., a near-coprocessor bus wrapper), providing a direct access register (DAR) that when accessed causes DAR and/or IAR contents to be used for a register transaction write request to the access bridge, allowing read access to DAR to produce register transaction read requests and provide read data back to the host (e.g., a host chiplet with a processor and software support), allowing the host to assert a soft reset to C2C/P2C register contents, supporting read transactions to a local status register, supporting register write burst transactions for quicker bring-up of chiplets (e.g., bring-up of XSR link datapaths), reading access to a data-only register without causing a register transaction (which may be helpful for test purposes), supporting acknowledgment/non-acknowledgement transmission for permissible or non-permissible inputs from the host with respect to a C2C/P2C protocol, or supporting read transactions to a local error status register.

C2C may utilize I2C as a preferred embodiment because I2C is a two-wire simple serial interface that ensures robust data transfer between chiplets in a cost-effective way. I2C operates with low power overheads and may have minimal signal propagation delay, which may be useful for ensuring efficient communication.

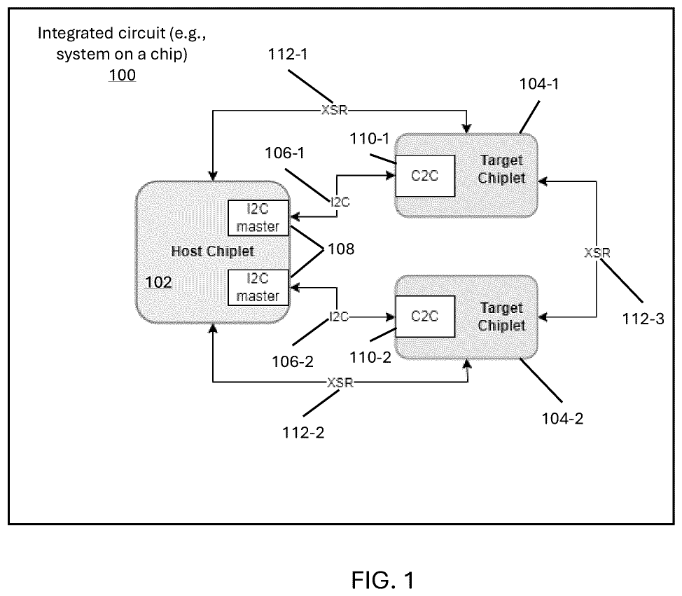

FIG. 1 illustrates schematically an example embodiment of an integrated circuit 100 including a host chiplet 102 and target chiplets 104-1, 104-2. The host chiplet 102 includes a processor capable of supporting software programming while the target chiplets 104-1, 104-2 lack support for software programming. The target chiplets 104-1, 104-2 are communicatively coupled to the host chiplet 102 via serial peripheral communication interfaces (e.g., I2C interface 106-1, 106-2, respectively). In particular, the host chiplet includes an I2C master module 108 configured to transmit commands to respective C2C modules 110-1, 110-2 (communication modules) of the target chiplets 104-1, 104-2. The host chiplet 102 and the target chiplets 104-1, 104-2 are further communicatively coupled via chiplet interconnects, e.g., extra short reach (XSR) interconnects 112-1, 112-2, 112-3. Registers of the target chiplets 104-1, 104-2 dedicated to chiplet communication over XSR interconnects, e.g., XSR interconnects 112-1, 112-2, 112-3, may be configured using commands transmitted from the host chiplet 102 to the target chiplets 104-1, 104-2 via the I2C interfaces 106-1, 106-2.

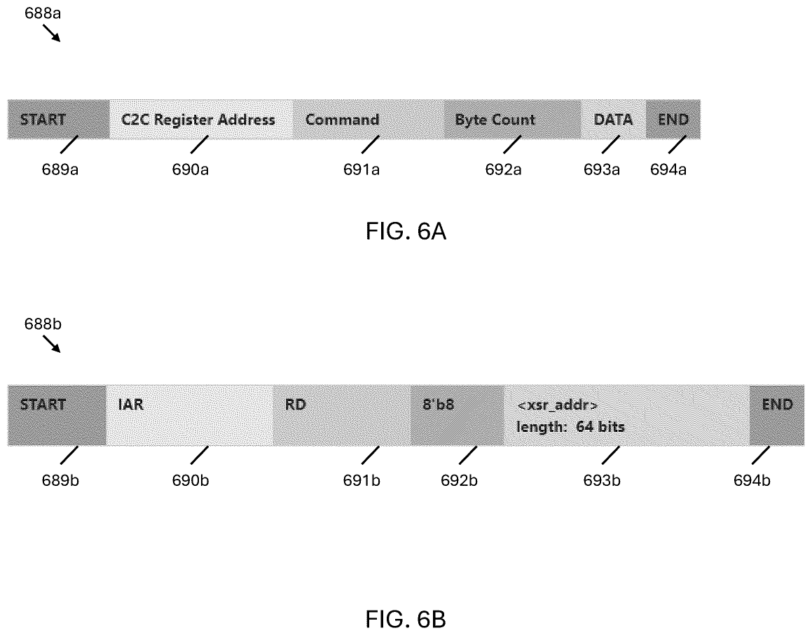

A method for chiplet communication utilized by the integrated circuit 100 of FIG. 1 may include transmitting a command from host chiplet 102 to a target chiplet, e.g., a chiplet of the target chiplets 104-1, 104-2, via a serial peripheral communication interface, e.g., the I2C interfaces 106-1, 106-2. The method may further include parsing, by the target chiplet in an uninitialized state, the command transmitted into a packet associated with an operation performable by the chiplet and performing, by the chiplet in the uninitialized state, the operation based on the packet parsed. Packets are further described hereinbelow with reference to FIGS. 6A and 6B.

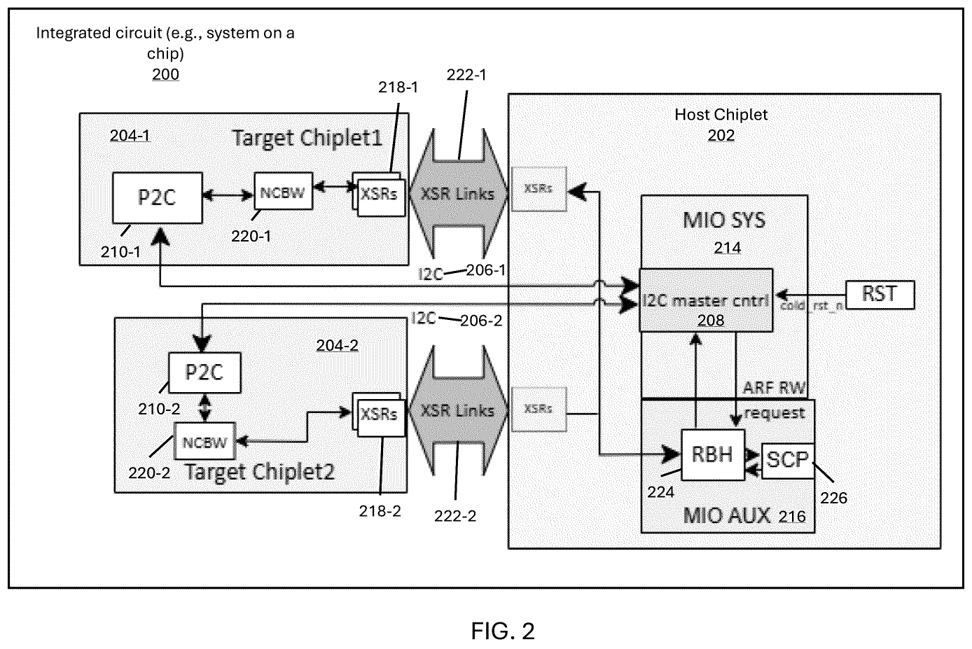

FIG. 2 illustrates schematically another example embodiment of an integrated circuit 200 including a host chiplet 202 and target chiplets 204-1, 204-2. The integrated circuit 200 may be similar to the integrated circuit 100 described herein with reference to FIG. 1, with corresponding elements labeled using like reference numbers but incremented by 100. The host chiplet 202 includes a miscellaneous input/output (MIO) module, which may further include an MIO system component 214 and an MIO auxiliary component 216. The MIO system component 214 may include an I2C master control 208 configured to transmit signals to the target chiplets 204-1, 204-2 via I2C interfaces 206-1, 206-2. The target chiplets 204-1, 204-2 include respective P2C modules 210-1, 210-2 communicatively coupled to the I2C master control 208 via the I2C interfaces 206-1, 206-2. The P2C modules 210-1, 210-2 may be configured to process instructions transmitted from the I2C master control 208 to perform desired operations, e.g., programming XSR interconnect registers 218-1, 218-2, based on commands received from the master control 208. In some embodiments, the P2C modules 210-1, 210-2 may be configured to process the instructions and to further transmit the instructions to a register controller of a baseband physical layer (BPHY) via an access bridge that connects the BPHY to a compute input/output bus, e.g., the P2C modules 210-1, 210-2. In some embodiments, the access bridge may include a register interface, for example, near coprocessor bus wrappers (NCBWs) 220-1, 220-2.

XSR interconnects, which may also be referred to as XSR links 222-1, 222-2, communicatively couple the target chiplets 204-1, 204-2 and the host chiplet 202 and may be used for low latency communication between the chiplets. The MIO auxiliary component includes a register broadcast hub (RBH) 224 configured for receiving requests from one or more sources, processing the requests, and broadcasting the requests to downstream devices, e.g., the target chiplets 204-1, 204-2. For example, the RBH 224 may broadcast to the target chiplets using the XSR links 222-1, 222-2. The RBH 224 may also be configured to receive data transmitted from the downstream devices. In some embodiments, the RBH 224 may be communicatively coupled to a system control processor (SCP) 226, which may be configured at least in part for running boot sequences and for booting a system.

According to some embodiments, a dedicated I2C bus (point-to-point) connection may be implemented between an MIO (for example, the MIO of the host chiplet 202), and all target chiplets. The host chiplet may include the I2C master block instantiated in the MIO 202 and control blocks, e.g., a control processors cluster (CPC) or RBH blocks for XSR bring-up in the target chiplet. The target chiplets may include an I2C slave, which may be, for example, included in the P2C module 210-1, 210-2, to read data from the master block of the host chiplet.

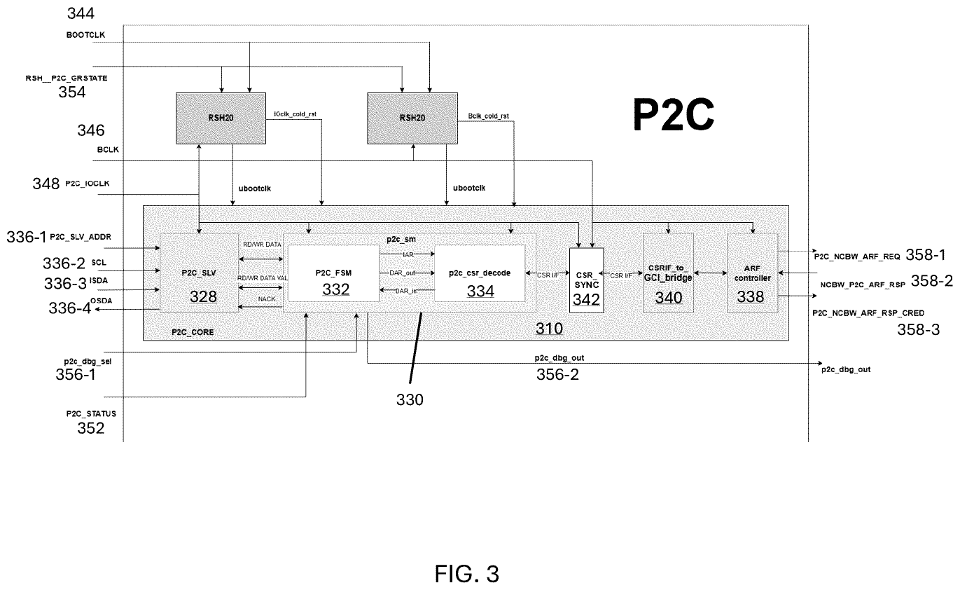

A C2C block, e.g., the P2C modules 210-1, 210-2, may handle functioning of an I2C slave with respect to a host chiplet, e.g., the host chiplet 202, communicating via an I2C bus interface. The C2C block may also serve a request received as an I2C slave to a general control interface (GCI) bridge to eventually communicate requests from the host chiplet to XSR blocks in the target chiplet. An example embodiment of a GCI bridge is described further herein with reference to FIG. 3. Registers of the target chiplets may be hardware programmed with respect to a GCI interface and an I2C interface. No external programming may be required for this process. A CPC may wait until a target chiplet is out of reset (e.g., by monitoring a P2C status register of the target chiplet) and initiate a transaction, e.g., bringing up XSR in the target chiplet.

FIG. 3 illustrates schematically an example embodiment of C2C module 310 of a target chiplet. The C2C module 310, which may be referred to as a P2C core (P2C_CORE), includes a communication module (P2C_SLV) 328 and hardware logic, e.g., a state machine (P2C_SM) 330. The C2C module 310 is configured to couple communicatively to a host chiplet (not shown, but similar with respect to the host chiplet 102, 202 of FIGS. 1 and 2) via a serial peripheral communication interface, e.g., I2C. The communication module may be configured to receive a plurality of inputs, including, for example, a serial clock (SCL) 336-1, an input serial data (ISDA) 336-2, and register addresses (P2C_SLV_ADDR) 336-3 from a host chiplet, and may be configured to transmit output serial data (OSDA) 336-4 to the host chiplet. The communication module 328 is further communicatively coupled to the state machine 330. Read/write data (RD/WR DATA) and/or read/write data values (RD/WR DATA VAL) may be transmitted between the communication module 328 and the state machine 330, and the state machine may transmit acknowledge (ACK) or not acknowledge signals (NACK) to the communication module.

Components of the C2C module 310 may receive additional inputs from the host module or an overarching system. Such inputs may include, as non-limiting examples, a boot clock (BOOTCLK) 344, a baseband clock (BCLK) 346, a P2C input output clock (P2C_IOCLK) 348, a status input (P2C_STATUS 352) from other BPHY components or parameters, or a global reset state (RSH_P2C_GRSTATE) 354. In some embodiments, the state machine 330 may be configured to receive a debug request (p2c_dbg_sel) 356-1 or transmit a debug output (p2c_dbg_out) 356-2.

The state machine 330 may be configured to process requests or instructions received by the communication module 328 from the host chiplet. According to an example embodiment, the state machine 330 may convert a request or instruction transmitted in a serial format to a control status register (CSR) interface format request. The state machine 330 may further transmit the CSR interface (CSRIF) format request to a register controller, e.g., an advanced register fabric (ARF) controller 338, via a bridge 340. The bridge 340, for example, a CSRIF to general controller interface (GCI) bridge may convert a request or instruction from a given format, e.g., a CSRIF format, to another given format, e.g., a GCI format, or vice versa depending on a direction of communication. The request in the CSRIF format may also undergo synchronization, for example, with reference to the BPHY clock, in a synchronization block 342. The ARF controller 338 may be communicatively coupled to, for example, an NCBW target, and may be configured to transmit to the NCBW target an ARF transaction request (P2C_NCBW_ARF_REQ) 358-1, receive from the NCBW target an ARF transaction response (P2C_NCBW_ARF_RSP) 358-2, or transmit to the NCBW target a response credit return output (P2C_NCBW_ARF_RSP_CRED) 358-3.

In some embodiments, the state machine 330 may provide an indirect address register (IAR) for downstream register transactions, for example, through a NCBW as illustrated in FIG. 2. The state machine may also provide a data access register (DAR) that when accessed causes the DAR (and/or the IAR) contents to be used for the register transactions. The register transactions may be handled by, for example, the ARF controller 338. The DAR may also be used to produce register read requests and to provide read data back to a host, e.g., the host chiplet. The state machine 330 may further support read transactions to a local status register.

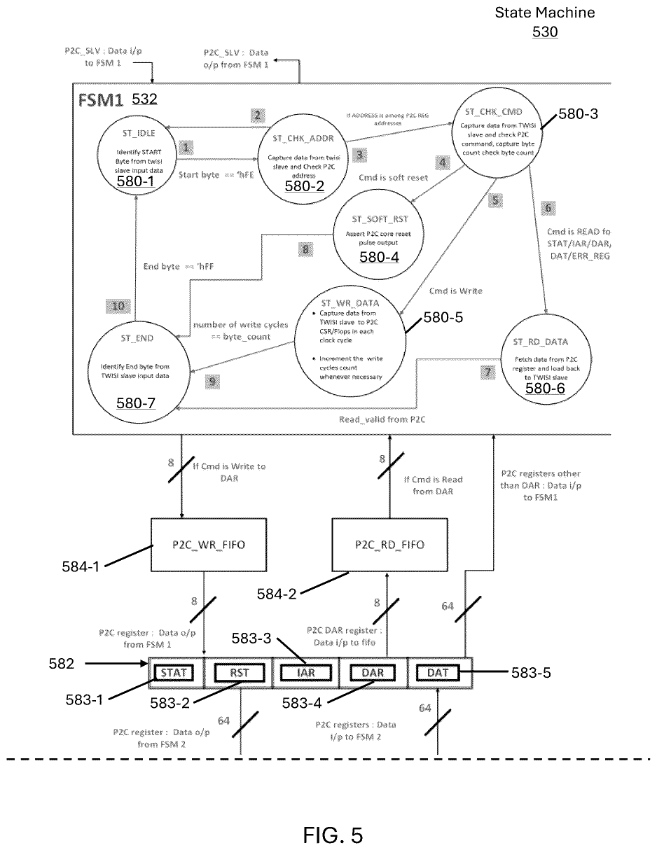

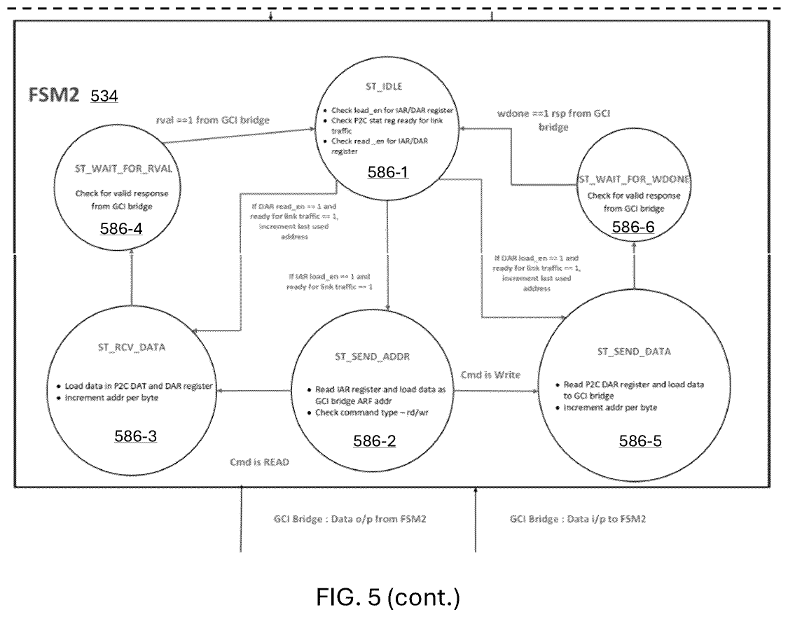

The state machine 330 may include one or more blocks. For example, as illustrated in the example embodiment of FIG. 3, the state machine 330 includes a first block (P2C_FSM) 332 and a second block (p2c_csr_decode) 334. States of a state machine are further described hereinbelow with reference to FIG. 5. The first block 332 may be communicatively coupled to the communication module 328 and may be configured to receive a request or instruction from the communication module 328 and to determine an operation or transaction based on the request received. The request may include information to be written to or read from a register of the C2C module 310, for example, a status register, an IAR, a DAR, or data only (DAT) of the state machine 330. The second block 334 may be communicatively coupled to the bridge 340 and may be configured to load data to the bridge 340 or to retrieve data from the bridge 340.

In some example embodiments, the C2C module 310 may include additional blocks, for example, reset hub (RSH) blocks 344-1, 344-2. The RSH blocks 344-1, 344-2 may receive signals from, for example, one or more clocks (which may include the baseband clock 346, the reference clock 344, or the input/output clock 348) and the global reset state 354. The RSH blocks 344-1, 344-2 may be configured to assert a reset of one or more components of the C2C module 310. The RSH blocks may also be configured to transmit an unconditional boot clock (ubootclk) to the C2C module 310.

While FIG. 3 illustrates a block diagram of a specific embodiment of a chiplet, it should be understood that the specific embodiment is provided for purposes of enablement and exemplification and that other methods or systems of receiving a command from a host chiplet and propagating said command into a hardware-level operation may be used. As a non-limiting example, while the example embodiment includes an inter-integrated circuit (I2C) interface, alternative serial peripheral communication interfaces, e.g., serial peripheral interface (SPI) or improved inter-integrated circuit (I3C) interfaces may be used for communication between the host chiplet and the target chiplet. Other register controllers, bridges, hardware logic, synchronization blocks, or any combination thereof may also be used for chiplet communication.

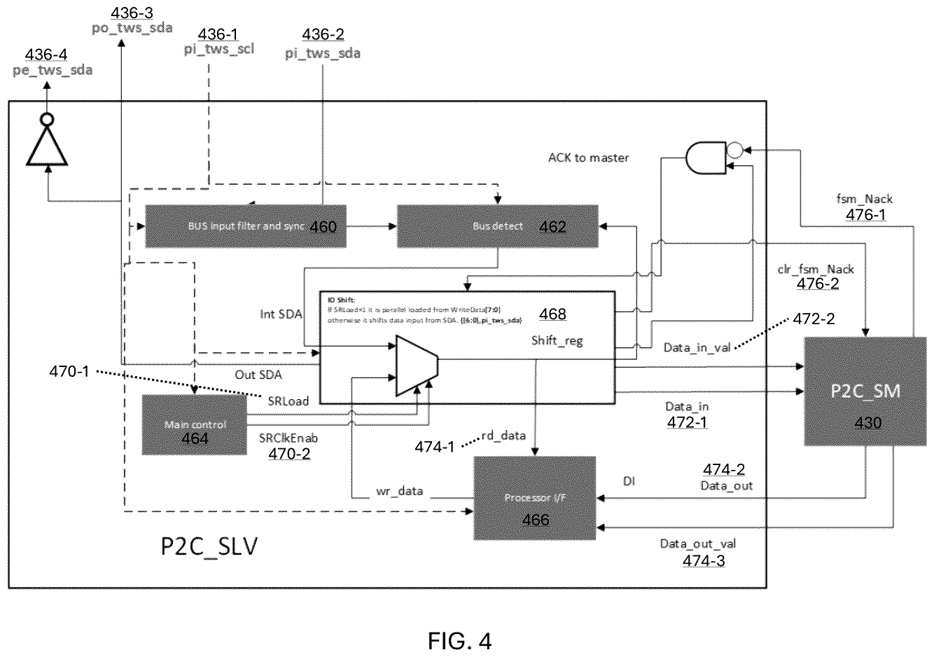

FIG. 4 illustrates schematically a block diagram of a C2C communication module 428 (P2C_SLV), according to an example embodiment. The communication module 428 may be similar to the communication module 328 described herein with reference to FIG. 3. As described herein, the communication module 428 may be communicatively coupled to a host chiplet via a serial peripheral communication interface such as I2C. In the example embodiment, the communication module 428 receives as inputs a serial clock (pi_tws_scl) 436-1 and serial data input (pi_tws_sda) 436-2 and transmits as outputs a serial data enable output signal (pe_tws_sda) 436-4 and a serial data output (po_tws_sda) 436-3. The serial clock 436-1 input may be routed to one or more blocks, which may include an input filter and synchronization block 460, a detection block 462, a main control block 464, a processer interface block 466, or a shift register block 468. The serial data input 436-2 received may be transmitted through the input filter and synchronization block 460 and the detection block 462 (which may detect, for example, a start command or an end/stop command) to the shift register block 468.

The shift register block 468 may receive input signals 436-1, 436-2 from the host chiplet and may transmit serial output signals 436-3, 436-4 to the host chiplet and to a state machine (P2C_SM) 430 communicatively coupled to the communication module 428. In some embodiments, the shift register block may convert serial data to bus data or parallel data. Additionally, in some embodiments, the shift register block 468 may further receive from the main control 464 block a shift register load (SRLoad) flag 470-1, a shift register clock enable (SRClkEnab) flag 470-2, or a combination thereof. The SRLoad flag 470-1 may be used to indicate whether data from the serial data input channel 436-1 should be shifted or parallel loaded. The shift register block 468 may write input data (Data_in) 472-1 to the state machine 430 based on the serial data input to the state machine, with an accompanying data input valid flag (Data_in_val) 472-2 that may indicate a valid or invalid write action. The processor interface (processor I/F) block 466 may be configured to be an interface for processor communications. The processor I/F block 466 may be configured to receive a read command (rd_data) 474-1 from the shift register block 468 and may be configured to receive read data (Data_out) 474-2 from the state machine 430, which may be accompanied by an output data valid flag (Data_out_val) 474-3 that may indicate a valid or invalid read action. The processor interface block 466 may convert the read data into a serial format and transmit serialized read data to the shift register block 468. The serialized read data received by the shift register block from the processor interface block 468 may be transmitted to the host module via the serial data output channel 436-3. In some embodiments, the shift register block 468 may further receive acknowledge/not acknowledge signals (fsm_Nack) 476-1 from the state machine, which may be in response to data written to the state machine or to read commands to the state machine, and may transmit a clear fsm_Nack command (clr_fsm_Nack) 476-2 to the state machine to clear a Nack buffer or register.

A communication module, e.g., the communication module 428, may carry the functionality of an I2C bus slave, wherein the communication module receives serial data and clock input from a master and propagates data bytes corresponding to the serial data accordingly to a state machine, e.g., the state machine 430. The communication module may run on an input/output clock (IOCLK) and the I2C may be based on a standard I2C protocol. The communication module may also propagate not-acknowledged signals coming from the state machine, combine logic with slave acknowledge logic, and determine a final acknowledge/non-acknowledge signal for the I2C master.

FIG. 5 illustrates schematically states of a state machine 530 that may be used for chiplet communication, according to an example embodiment. The state machine 530 may be similar to the state machine 330 described herein with reference to FIG. 3 and may be, for example, implemented on a target chiplet. The state machine 530 may be configured to transition between the states based on commands transmitted from a host chiplet and subsequently through a communication module communicatively coupled to the state machine. Example embodiments of command packets and structures thereof are further described herein with reference to FIGS. 6A and 6B.

The state machine 530 of FIG. 5 includes, similar to the state machine 430 described herein with reference to FIG. 3, a first block (FSM1) 532 and a second block (FSM2) 534. The first block 532 may be configured to receive data from a communication module (P2C_SLV) or transmit data to the communication module. The first block 532 may include an idle state (ST_IDLE of FSM1) 580-1 and may remain in the idle state 580-1 until receiving a start byte. Upon receiving the start bite, the first block 532 may transition [1] from the idle state 580-1 to a check address state (ST_CHK_ADDR) 580-2. The check address state 580-2 captures data received from the communication module and checks a C2C (or P2C) address. If the C2C address is not a valid address among C2C register addresses, the first block 532 transitions [2] from the check address state 580-2 to the idle state 580-1. If the C2C address is a valid address among the C2C register addresses, the first block 532 transitions [3] from the check address state 580-2 to a check command state (ST_CHK_CMD) 580-3. The check command state 580-3 further captures data from the communication module and checks a C2C command and captures a byte count. Based on the C2C command, the check command state 580-3 may transition to a number of states, which may include one or more of: [4] from the check command state 580-3 to a soft reset state 580-4 if the command is a soft reset command, [5] from the check command state 580-3 to a write data state 580-5 if the command is a write command, and [6] from the check command state 580-3 to a read data state 580-6 if the command is a read command.

In the soft reset state 580-4, the first block asserts a C2C core reset pulse output and transitions [8] from the soft reset state 580-4 to an end state 580-7, wherein the first block 532 identifies an end byte from the data received from the communication module. Upon identifying the end byte, the first block 532 transitions [10] from the end state 580-7 to the idle state 580-1.

In the write state 580-5, the first block 532 captures data received from the communication module and writes to a C2C control/configuration and status register (CSR)/flops in each clock cycle. A write cycles count may be incremented whenever necessary and a number of write cycles may be determined by the byte count identified in the check command state 580-3. After the write transaction, the first block 532 transitions [9] from the write state 580-5 to the end state 580-7 and similarly [10] from the end state 580-7 to the idle state 580-1 upon identifying the end byte.

In the read state 580-6, the first block 532 fetches data from a C2C register and loads the data from the C2C register fetched to the communication module. Upon execution of the read operation, the first block 532 transitions [7] from the read state 580-6 to the end state 580-7 and similarly [10] from the end state 580-7 to the idle state 580-1 upon identifying the end byte.

From any given state of the first block 532, the state may return to the idle state 580-1 due to a timeout while waiting for a corresponding input packet. Example state transitions of the first block 532 of the state machine 530 are provided in Table 1.

TABLE 1
Example State Transition Table for Path from Communication Module to CSR

| Present State | Next State | Transition Conditions | Error scenario handling |
|---|---|---|---|
| ST_IDLE | ST_CHK_ADDR | Start_byte value identified from | |
| ST_CHK_ADDR | ST_CHK_CMD | Valid P2C address | Invalid P2C address |
| | | Send ACK | |
| | ST_IDLE | Timeout while waiting for address input | |
| | | packet | |
| ST_CHK_CMD | ST_RD_DATA | Command byte value denotes | Invalid P2C Command |
| | | read/check status | |
| | ST_WR_DATA | Command byte value denotes write | |
| | ST_SEND_SOFT_RST | Command byte value denotes write | |
| | ST_IDLE | Timeout while waiting for command | |
| | | input packet | |
| ST_RD_DATA | ST_END | P2C register read FIFO valid equals 1 | Timeout |
| | ST_IDLE | Timeout while waiting for command | |
| | | input packet | |
| ST_WR_DATA | ST_END | Number of wait cycles equals expected | Timeout |
| | | byte count | |
| | ST_IDLE | Timeout while waiting for command | |
| | | input packet | |
| ST_SEND_SOFT_RST | ST_END | Soft Reset bit output pulse from P2C | State Machine unable to reset |
| | | FSM to tie to P2C core reset input | P2C module |
| ST_END | ST_IDLE | End byte value identified | Invalid END byte |
| | ST_IDLE | Timeout while waiting for command input | |
| | | packet | |

The first block 532 and the second block 534 may be communicatively coupled to C2C registers 582, which may include, for example, control/configuration and status registers. The C2C registers may include one or more of a status register (STAT) 583-1, a reset register (RST) 583-2, an indirect address register (IAR) 583-3, a direct access register (DAR) 583-4, a data only register (DAT) 583-5, or other types of registers. The first block 532 may be configured to write to the DAR 583-4 register via a write first-in-first-out block (P2C_WR_FIFO) 584-1 when the command received is a write to DAR command. Similarly, the first block 532 may be configured to read from the DAR register 583-4 via a read first-in-first-out block (P2C_RD_FIFO) 584-2 when the command received is a read from DAR command. For commands other than reading from the DAR or writing to the DAR, the first block 532 may output to or receive an input from the C2C registers 582 directly.

The C2C registers 582 may output to the second block 534 or receive as inputs data from the second block 534. The second block 534 may further be configured to communicate with a GCI bridge, for example, the GCI bridge 340 described herein with reference to FIG. 3. The second block 534 may include a second block idle state (ST_IDLE of FMS2) 586-1, at which the second block 534 may check for a load enable flag associated with the IAR 583-3 or the DAR 583-4, check for a read enable flag for the IAR 583-3 or the DAR 583-4, or check the status register 583-1 to determine readiness for link traffic. If the load enable flag of the IAR register 583-3 indicates readiness for a load operation and the status register 583-1 indicates readiness for link traffic, the second block 534 transitions from the idle state 586-1 to a send address state (ST_SEND_ADDR) 586-2, wherein the second block 534 reads the IAR 583-3 and loads data of the IAR 583-3 as a GCI bridge ARF address. If the command type is a read command, the second block 534 transitions from the send address state 586-2 to a receive data state (ST_RCV_DATA) 586-3, wherein the second block 534 loads data from the GCI bridge ARF address to the DAT 583-5 and the DAR 583-4 while incrementing the address per byte. The second block 534 subsequently transitions from the receive data state 586-3 to a waiting for read value state (ST_WAIT_FOR_RVAL) 586-4, wherein the second block 534 checks for a valid response from the GCI bridge, and, upon a read valid flag from the GCI bridge, transitions from the wait for read value state 586-4 to the second block idle state 586-1. If the command is a write command, the second block 534 transitions from the send address state 568-2 to the send data state (ST_SEND_DATA) 586-5, wherein the second block 534 reads data from the DAR register 583-4 and loads the data read to the GCI bridge while incrementing the GCI bridge ARF address per byte. The second block 534 subsequently transitions from the send data state 586-5 to a wait for write done state (ST_WAIT_FOR_WDONE) 586-6, wherein the second block 534 checks for a valid response from the GCI bridge, and, upon receiving a write done flag from the GCI bridge, transitions from the waiting for write done state 586-6 to the second block idle state 586-1. Example state transitions of the second block 534 of the state machine 530 are disclosed in Table 2.

TABLE 2
Example State Transition Table for Path from CSR to GCI

| Present State | Next State | Conditions |
|---|---|---|
| ST_IDLE | ST_SEND_ADDR | IAR_load_en == 1 |
| | ST_SEND_DATA | DAR_load_en == 1 |
| | ST_RCV_DATA | DAR_read_en == 1 |
| ST_SEND_ADDR | ST_SEND_DATA | CMD_reg_data = ‘WR_CMD |
| | ST_RCV_DATA | CMD_reg_data = ‘RD_CMD |
| ST_SEND_DATA | ST_WAIT_FOR_WDONE | one clock cycle |
| ST_RCV_DATA | ST_WAIT_FOR_RVAL | one clock cycle |
| ST_WAIT_FOR_WDONE | ST_IDLE | Response from GCI bridge wdone == 1 |
| ST_WAIT_FOR_RVAL | ST_IDLE | Response from GCI bridge rval == 1 |

If the read enable flag associated with the DAR 583-4 indicates readiness for a read operation and the status register indicates readiness for link traffic, the second block 534 may increment a last used address and transition from the second block idle state 586-1 to the receive data state 586-3. If the load enable flag indicates readiness for a load operation and the status register flag indicates readiness for link traffic, the second block 534 may increment the last used address and transition from the second block idle state 586-1 to the send data state 586-5. The second block may follow similar state transitions as described hereinabove to return to the second block idle state 586-1 from the receive data state 586-3 or the send data state 586-5.

A C2C module, e.g., the C2C module 110-1, 110-2, 210-1, 210-2, 310 described herein with reference to FIGS. 1-3, may be configured to receive and to parse signals transmitted using a predefined packet format. As illustrated in FIGS. 6A and 6B and as disclosed herein, the packet format may include one or more of a start field, an end field, a C2C/P2C register address field, a command field, a byte count field, a data field, or any combination thereof. The C2C module may be configured, for example, to parse a command transmitted to a target chiplet having the C2C module and/or to convert a serial data input received over a serial interface, e.g., I2C, into a format suitable for use for configuring registers of the target chiplet, for example, a GCI format.

FIG. 6A illustrates a template for a packet 688a transmitted from a host chiplet to a target chiplet using C2C communication, according to an example embodiment. The packet begins with a start block 689a and concludes with an end block 690a. The start block 689a and the end block 690a may be fixed values interpretable by a C2C communication module. The start block 689a is followed by a C2C Register Address 691a, which may be used to indicate an address of a register at which an operation is to be performed. According to an example embodiment, the registers may include one or more of: a status register of the target chiplet (STAT), a reset register (RST), an indirect address register (IAR) to which a command may be performed, or data registers (e.g., direct access register (DAR) or data only register (DAT)). The command, e.g., a read or write transaction, may be provided in a Command block 692a. The packet may further include a byte count block 693a that includes a value corresponding to a number of bytes of data in a data block 694a subsequent to the byte count block. Some of the blocks of the packet 688a, e.g., the start block 689a or the end block 690a, may be of a fixed block size, e.g., a byte, and some of the blocks of the packet 688a may be of variable sizes based on an application or a chiplet, e.g., the data block 694a.

FIG. 6B illustrates an example packet 688b that may be transmitted from a host chiplet to a target chiplet following the template of FIG. 6A. The packet 688b includes the start block 689b and the end block 690b. Between the start block 689b and the end block 689b, the packet 688b includes a C2C Register Address 691b representative of IAR, which indicates subsequent blocks to be transmitted include an address register. The packet 688b further includes a read command 692b followed by a byte count block representative of 8 bytes 693b and an XSR register address 694b. In an example embodiment, the XSR register address is of size 8 bytes or 64 bits.

Values that may be used for blocks or fields of a packet, according to an example embodiment, are disclosed in Table 3 and byte count values associated with each C2C address, according to an example embodiment, are disclosed in Table 4.

TABLE 3
Example C2C Packet Format and Registers

| P2C | Register | | | |
|---|---|---|---|---|
| Address | name | Descriptions | Attribute | Comments |
| 0 | STATUS | Bit 0 = | Read | Bit 39 . . . 0 contents may include general |
| | | CHIP_RST_N | Only | BPHY parameters set via P2C_STATUS |
| | | Bits 2 . . . 1 = NODE_ID | (RO) | input from other BPHY components |
| | | Bits 5 . . . 3 = | | Bit 0 Local chip reset Default value of 1 after local |
| | | NUM_XSRS | | chip reset. |
| | | Bits 7 . . . 6 = RAZ (Reserved) | | Bit 2 . . . 1 Node ID is specific to a target chiplet and is |
| | | Bits 15 . . . 8 = RAZ | | tied off to a default value |
| | | (Reserved) | | Bit 5 . . . 3 Number of XSRs is tied off to a specific |
| | | Bits 23 . . . 16 = | | value based on the number of XSRs connected to |
| | | CHIP_TYPE | | the Target chiplet. |
| | | Bits 31 . . . 24 = | | Bit 15 . . . 6 Reserved |
| | | CHIPLET_ID | | Bit 23 . . . 16: Value of Chip type (=BPHY chip type) |
| | | Bits 39 . . . 32 = | | Bit 31 . . . 24: Value of Revision ID of the chiplet |
| | | BPHY_GEN | | Bits 39 . . . 32 = BPHY general status port (can be used |
| | | Bits 43 . . . 40 = | | by any other BPHY IP to store status) |
| | | ARF_WR_BYTE_CNT_PREV | | Bit 63 . . . 38 may include internal signals of P2C |
| | | Bits 47 . . . 44 = | | state machine |
| | | ARF_RD_BYTE_CNT_PREV | | Default values: 0 for all 3 register fields |
| | | Bits 55 . . . 48 = | | Bit 47 . . . 40 P2C to NCBW ARF Write Byte count |
| | | I2C_WR_RD_BYTE_CNT_PREV | | of P2C transaction just previous to P2C status read |
| | | Bits 63 . . . 56 = | | from Master |
| | | <FSM1_STATE, | | Bit 55 . . . 48 NCBW to P2C ARF Read Write Byte |
| | | FSM2_STATE> | | count of P2C transaction just previous to P2C |
| | | | | status read from Master |
| | | | | Bit 63 . . . 56 Master to P2C Write and read data |
| | | | | combined byte count for transaction just previous |
| | | | | to P2C status read from master |
| 1 | SOFT_RST | Reset | Write | Write to this register for soft reset of P2C_core |
| | | 0 = No reset/Out of reset | Only | Default value: 0 |
| | | Reset 1 = Command P2C for soft | (WO) | Master should write 1 to reset p2c core. |
| | | reset | | P2C will internally generate a reset pulse to p2c core |
| | | | | and then P2C will internally write back 0 once out of |
| | | | | reset |
| 2 | IAR | Indirect Address Register | Read/Write | This 48 bit register is written first by I2C master |
| | | 47 . . . 0 Address used for ARF | (R/W) | |
| | | Node field is ignored. | | |
| | | All other bits are reserved . . . | | |
| 3 | DAR | Data Access Register | R/W | 1, 2, 4, 8 and greater than 8 bytes of data to be |
| | | 63 . . . 0 Data | | written to target chiplet XSRs. 8 bytes of data to be |
| | | Access shall result in ARF | | read from target chiplet XSRs. |
| | | transaction | | |
| 4 | DAT | Data Only (No ARF) | RO | Used for debug purposes. Data written in DAR is |
| | | 63 . . . 0 Data | | parallelly copied in this register for reference. |
| 5 | ERR_STATUS | [2 . . . 0]: Error Code Value | R/W1C/H | Typical value is 0 |
| | | All other bits | | 0: No error |
| | | are reserved | | 1: Write data capacity limit reached |
| | | | | 2: P2C NCBW Read transaction timeout |
| | | | | 3: P2C NCBW Write transaction timeout |
| | | | | 4: Master P2C SLV trasanction timeout |
| | | | | Master shall read error status for debug purpose and |
| | | | | write 1 to clear it |

TABLE 4
Example Command Addresses and Permissible Operations

| P2C | | |
|---|---|---|
| Address | Read byte count | Write byte count |
| STATUS | 1-8 | Not programmed |
| | | through SDA lines |
| | | (Master) (STAT register |
| | | loaded via P2C_STATus |
| | | input port) |
| SOFT_RST | Read not permitted | 1 |
| IAR | 6 | 6 |
| DAR | 8 | 1, 2, 4, 8 and greater than 8 only |
| DAT | 1-8 | Write not permitted |
| ERR_STATUS | 1 | 1 |

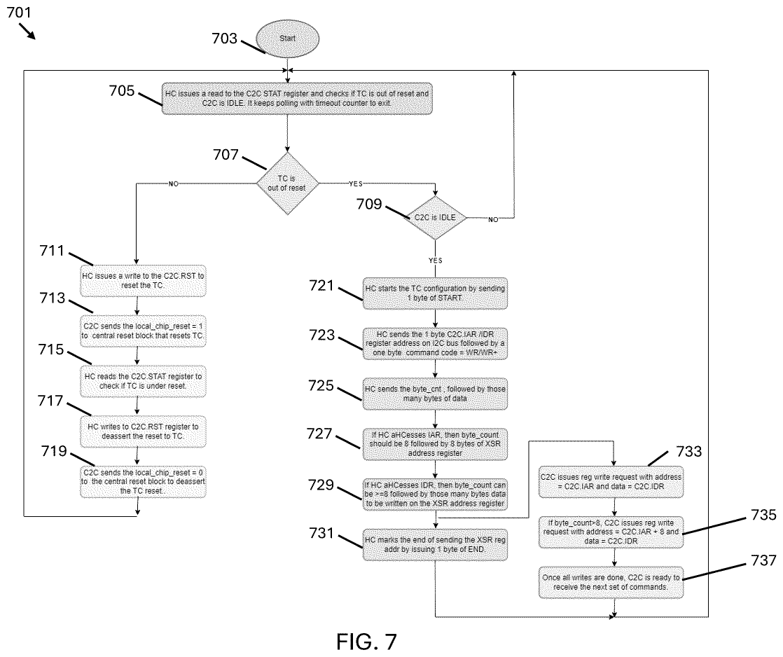

FIG. 7 illustrates an example embodiment of a workflow 701 for configuring a target chiplet in a system with heterogenous chiplet architecture. Upon starting 703, a host chiplet issues 705 a read command to a C2C STAT (status) register of a target chiplet checks if a target chiplet is out of reset 707 and a C2C communication module of the target chiplet is idle 709. The host chiplet may continue polling using a timeout counter to exit. If a target chiplet is not out of reset (NO path from TC is out of reset 707), the host chiplet may reset the target chiplet. The host chiplet issues 711 a write command to the C2C RST register of the target chiplet to reset the target chiplet. The C2C module sends 713 a signal (e.g., local_chip_reset=1) to a central reset block that resets the target chiplet. The host chiplet can read 715 the C2C STAT register to check if the target chiplet is under reset. Upon identifying the target chiplet is under reset, the host chiplet writes 717 to the C2C RST register to deassert the reset to the target chiplet. The C2C module subsequently sends 719 a signal (e.g., local_chip_reset=0) to the central reset block to deassert the target chiplet reset. The host chiplet will subsequently issue 705 read commands to the C2C STAT register to identify check if the target chiplet is out of reset and the C2C communication module is idle.

If the host chiplet identifies that the target chiplet is out of reset but that the C2C module is not idle (NO path from C2C is IDLE 709), the host chiplet may continue to issue 705 read commands to the C2C STAT register. Upon detecting the target chiplet is out of reset and the C2C module is idle (YES path from C2C is IDLE 709), the host chiplet may start the target chiplet configuration. According to the example embodiment, the host chiplet may start 721 the configuration by sending a 1 byte START signal. The host chiplet may subsequently send 723 a 1 byte C2C IAR/IDR address followed by a 1 byte command code. The command code may include, for example, read, write, or burst write. The host chiplet sends 725 a byte count followed by a corresponding number of bytes of data.

If the host chiplet accesses 727 a C2C IAR address, the byte count should be 8 and 8 bytes of XSR address register should follow after the byte count. The host chiplet marks 731 an end of sending the XSR address register by issuing a 1 byte END command. If the host chiplet accesses 729 a C2C IDR address, the byte count may be greater than or equal to 8 and a corresponding number of bytes of data to be written on an XSR address register, e.g., the XSR register address transmitted using the C2C IAR address. The C2C module issues 733 a register write request with the XSR address register previously transmitted and data transmitted under the C2C IDR register address. If the byte count is greater than 8, the C2C module issues 735 register write requests while incrementing the address provided under the C2C IAR register address. After all writes have been completed, the C2C module is 737 ready to receive further commands.

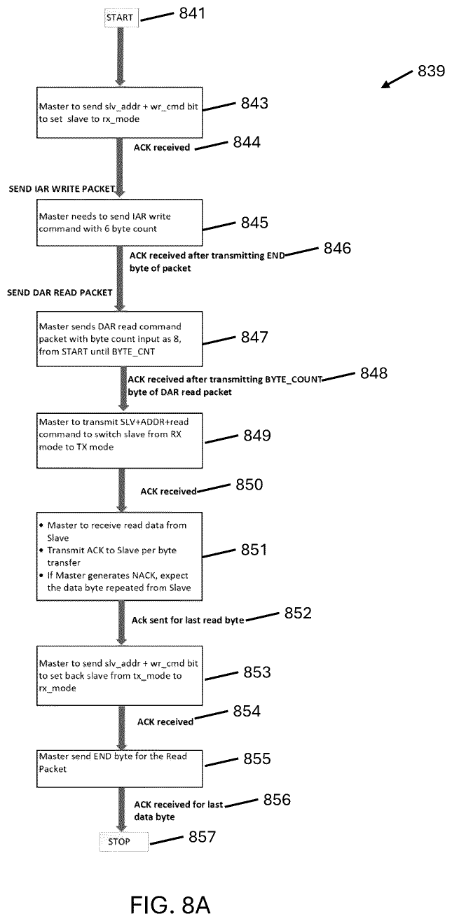

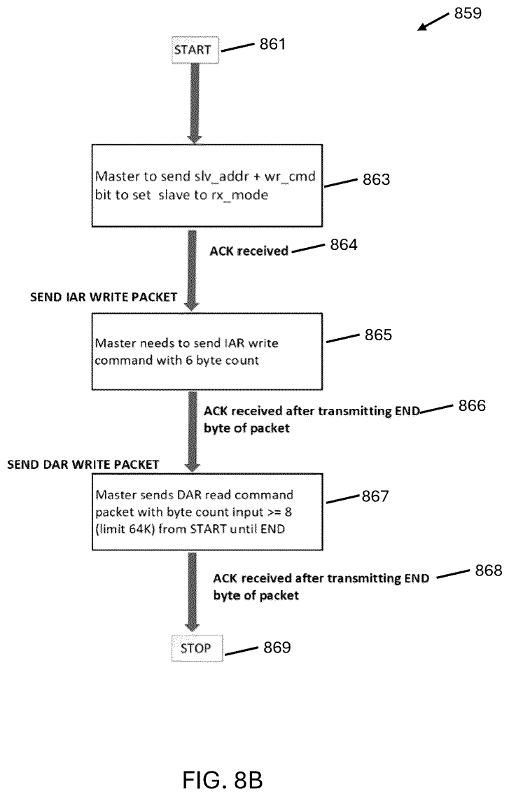

FIGS. 8A and 8B illustrate example workflows performed by a host chiplet for read and write transactions, respectively for registers of a target chiplet, according to an example embodiment. As illustrated in FIG. 8A, an example embodiment of a read transaction 839 may start 841 with a host chiplet (which may also be referred to as a master chiplet) sending 843 to a target chiplet (which may be referred to as a slave chiplet) a slave address (slv_addr) and a write command (wr_cmd) bit to set the slave chiplet to a receiver mode (rx_mode). The slave chiplet sends 844 an acknowledgement (ACK), after which the master chiplet sends an IAR write packet, wherein the master chiplet sends 845 an IAR write command, a byte count input value of 6, and 6 bytes of data. The target chiplet sends 846 an acknowledgement to the master chiplet upon receiving an end byte of the IAR write packet. The master chiplet subsequently transmits a DAR read packet, wherein the master chiplet sends 847 to the slave chiplet a DAR read command and a byte count input of 8. The master chiplet sends a packet from the start field to the byte-count field (example embodiments of packets are described herein with reference to FIGS. 6A and 6B), upon which the slave chiplet sends 848 to the master chiplet an acknowledgement after transmitting a byte count byte of the DAR read packet. The master chiplet then transmits 849 a command to switch the slave chiplet from receive mode to transfer (TX) by transmitting a slave address and read command by transmitting the slave address and a read command. The slave chiplet sends 850 an acknowledgment to the master chiplet, upon which the master chiplet receives 851 read data from the slave chiplet and transmits an acknowledgement to the slave chiplet per byte received. If the master chiplet generates a not acknowledgement, the master chiplet may expect the data byte to be repeated by the slave chiplet. The slave chiplet sends 852 an acknowledgement after the last read byte, after which the master chiplet sends 853 to the slave chiplet the slave address and the write command bit to set the slave chiplet from the transfer mode to the receive mode. The slave chiplet transmits an acknowledgement 854 and the master chiplet sends an end byte for the DAR read packet. The slave chiplet sends 856 an acknowledgement to the master chiplet for the end byte and the read transaction stops 857.

As illustrated in FIG. 8B, an example embodiment of a write transaction 859 may start 861 with a master chiplet sending 863 to the slave chiplet a slave address and a write command bit to set the slave chiplet in a receive mode. The slave chiplet sends 864 an acknowledgement and the master chiplet subsequently transmits an IAR write packet, wherein the master chiplet sends 865 an IAR write command, a byte count input value of 6, and 6 bytes of data. The slave chiplet sends 866 an acknowledgement after an end byte of the IAR write packet. The master chiplet then sends a DAR write packet, wherein the master chiplet sends 867 a DAR write command with a byte count input value of greater than or equal to 8, data with a size corresponding to the byte count input value, and an end byte. In some embodiments, a maximum limit of the byte count input value may be around 64,000. The slave chiplet sends an acknowledgement 868 after the end byte of the packet and the write transaction stops 869.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method of chiplet communication, the method comprising:
receiving, at a chiplet, a command via a serial peripheral communication interface;
parsing, by the chiplet in an uninitialized state, the command into a packet associated with an operation performable by the chiplet; and
performing, by the chiplet in the uninitialized state, the operation based on the command parsed.

2. The method of claim 1, wherein:
the operation performed includes resetting the chiplet, transmitting a status of the chiplet, writing a value to a register at a given address, or transmitting a value from the register at the given address.

3. The method of claim 2, wherein:
writing the value to the register at the given address initializes at least a portion of the chiplet.

4. The method of claim 3, wherein:
initializing at least a portion of the chiplet includes establishing a physical link layer configured to communicatively couple the chiplet to a host chiplet.

5. The method of claim 1, further comprising:
parsing, by the chiplet in an initialized state, a subsequent command into a subsequent packet associated with a subsequent operation performable by the chiplet; and
performing, by the chiplet in the initialized state, the subsequent operation based on the subsequent command parsed.

6. The method of claim 1, wherein:
performing the operation includes identifying a start field of the packet, checking a register address corresponding to a register address field of the packet, the register address associated with the operation, and identifying a command field of the packet.

7. A chiplet, comprising:
a communication module configured to couple communicatively to a host chiplet via a serial peripheral communication interface, the communication module further configured to, the chiplet being in an uninitialized state, convert signals received through the serial peripheral communication interface into a command; and
hardware logic communicatively coupled to the communication module, the hardware logic configured to, the chiplet being in the uninitialized state, execute the command.

8. The chiplet of claim 7, wherein:
the communication module includes a protocol layer, the protocol layer configured to parse the command into a packet associated with an operation performable by the hardware logic, and wherein the hardware logic executing the command includes performing the operation.

9. The chiplet of claim 8, wherein:
the operation performed includes resetting the chiplet, transmitting a status of the chiplet to the host chiplet, writing a value to a register at a given address, or transmitting the value from the register at the given address to the host chiplet.

10. The chiplet of claim 8, wherein:
the packet includes at least a start field, a register address field, a command field, and an end field.

11. The chiplet of claim 7, wherein:
the serial peripheral communication interface includes an inter-integrated circuit (I2C) communication interface.

12. The chiplet of claim 7, wherein:
the hardware logic includes a finite state machine, the finite state machine including logic for processing the command.

13. The chiplet of claim 7, further comprising:
a physical layer, the hardware logic configured to initialize at least a portion of the physical layer by executing the command.

14. The chiplet of claim 7, wherein:
the hardware logic is further configured to, the chiplet being in an initialized state, execute a subsequent command.

15. An integrated circuit, comprising:
a host chiplet;
at least one target chiplet, a chiplet of the at least one target chiplet including:
a communication module communicatively coupled to the host chiplet via a serial peripheral communication interface, the communication module configured to, the chiplet being in an uninitialized state, convert signals received through the serial peripheral communication interface into a command; and
hardware logic communicatively coupled to the communication module, the hardware logic configured to, the chiplet being in the uninitialized state, execute the command.

16. A target chiplet, comprising:
means for receiving a command via a serial peripheral communication interface;
means for parsing the command received into a packet associated with an operation performable by the chiplet in an uninitialized state;
means for performing the operation based on the command parsed.

17. A hardware description language (HDL) design structure encoded on a machine readable data storage medium, said HDL design structure comprising elements that when processed in a computer-aided design system generates a machine-executable representation of an initialization block of a chiplet, wherein the HDL design structure comprises:
a communication block configured to couple communicatively to a host chiplet via a serial peripheral communication interface, the communication module further configured to, the chiplet being in an uninitialized state, convert signals received through the serial peripheral communication interface into a command; and
hardware logic communicatively coupled to the communication block, the hardware logic configured to, the chiplet being in the uninitialized state, execute the command.
